(19) United States
(12) Patent Application Publication
(10) Pub. No.: US 2002/0004074 A1
(43) Pub. Date: Jan. 10, 2002

(54) Food composition containing fish oil and a fish oil stabilizing agent

(76) Inventors: Abraham I. Bakal, Padsippany, NJ (US); Richard W. Schoenfeld, Marshall, MN (US); Jane B. Crowther, Heathsville, VA (US); Penny A. Cash, Denville, NJ (US)

Correspondence Address: Attn: Stephen F. Schlather, BRACEWELL & PATTERSON, L.L.P., Suite 2900, 711 Louisiana, Houston, TX, 77002, US

(21) Appl. No.: 09/765,202

(22) Filed: Jan. 18, 2001

Related U.S. Application Data
(60) Provisional application No. 60/176,959, filed on Jan. 18, 2000.

(51) Int. Cl. A23L 1/24

(52) U.S. Cl. 424/602; 424/613

(57) ABSTRACT

A food composition containing a food product, fish oil, and a fish oil stabilizing agent. The fish oil is a nonhydrogenated fish oil containing omega-3 long chain fatty acids that has been deodorized and refined for packaging. The stabilizing agent consists of the citrus flavonoid naringin that is derived from the pulp and peel of grapefruit. The stabilizing agent comprises between about 0.003 weight percent of the food composition to about 0.02 weight percent of the food composition. The stabilizing agent protects the fish oil from taste and odor degradation, and allows for long term storage of the food composition containing the fish oil.

This application claims the benefit of U.S. Provisional Application No. 60/176,959 filed Jan. 18, 2000.

### BACKGROUND OF INVENTION

1. Field of Invention

The present invention relates to a food composition containing fish oil, and a stabilizing agent for stabilizing the fish oil. More specifically the stabilizing agent stabilizes the fish oil against flavor and odor degradation. The invention also relates to a method of preparing the food composition containing fish oil and a stabilizing agent for stabilizing the fish oil.

2. Description of the Prior Art

Certain fish and other marine animals contain oil rich in polyunsaturated fatty acids, such as eicosapentaenoic acid (EPA) and docosahexaenoic acids (DHA). Since these fatty acids have a double bond at the third carbon bond from the omega position of the fatty acid they are referred to as omega-3 fatty acids. The positive health effects of consuming fish oil containing omega-3 fatty acids have been widely reported in recent years (U.S. Pat. No. 5,006,281, issued Apr. 9, 1991 to Rubin et al., U.S. Pat. No. 4,963,380 issued Oct. 16, 1990 to Schroeder et al., and U.S. Pat. No. 4,874,629 issued Oct. 17, 1989 to Chang et al.—incorporated by reference herein). These positive health benefits have been seen in humans and in animals.

Unfortunately, untreated fish oils and more specifically fish oils containing omega-3 fatty acids inherently have an unsavory fish odor and flavor. Furthermore, untreated fish oils having omega-3 fatty acids are susceptible to oxidation. These fish oils after being oxidized will degrade after a period of hours, and diminish the omega-3 content of the fish oil.

The proposed solutions to solve the problem of the offensive odor and taste of the fish oil have involved stabilizing the fish oil or masking the fishy taste/odor inherent in the fish oil. Other processes to enhance fish oil palatability involve deodorizing the fish oil by removing the naturally occurring amines present in the fish oil (volatiles) that emanate the “fishy” odor. Deodorizing typically involves steam stripping the fish oil with high temperature steam in a vessel or container to remove the volatiles. Deodorizing fish oil containing omega-3 fatty acids has proven unsuitable since high temperature (above 470° F.) removes or damages the omega-3 fatty acids. As noted above loss of the omega-3 fatty acids eliminates a large portion of the health benefit of the fish oil. Other methods suggested to protect the fish oil against oxidation (thereby providing a stabilizing effect to the oil) involve adding anti-oxidants to the oil to protect the oil from subsequent oxidation. Simply adding anti-oxidants to the fish oil has failed to produce an edible fish oil suitable for long term storage since naturally occurring compounds in the fish oil, such as aldehydes, ketones, and carotenoids can seed peroxidation and must be removed to provide antioxidant effectiveness.

Sensory masking agents to mask the fish oil flavor and smell have been suggested as a way to eliminate the offensive nature of the fish oil. Taste and smell masking agents suggested consist of anethole, dihydroanethole, eugenol, and wintergreen. Taste masking agents such as vanillin, ethylvanillin, and ethylmaltol, have been suggested. Odor masking agents consist of natural and artificial fruit, citrus and mint including, lime, lemon, orange, pineapple, grapefruit, cinnamon, clove, bay, allspice, anise, spearmint, peppermint, benzaldehyde, and cherry. However few of sensory masking agents suggested successfully mask both odor and taste, and none to date provide long lasting positive effects to suppress the offensive nature of fish oil.

A yet further past attempt to stabilize fish oils containing omega-3 fatty acids has involved hydrogenating the fish oil. However, hydrogenation of the fish oil containing omega-3 fatty acids decreases the health benefit associated with such oils.

Irrespective of the odor and taste problems associated with fish oil, and fish oils containing omega-3 fatty acids in particular, there has been great interest in processing these oils for human consumption. The interest in human consumption is based on the health benefits of the fish oil containing omega-3 fatty acids, including reducing the risk of heart disease. Gelatin capsules containing fish oil with omega-3 fatty acids have been available to consumers for some time. In recent times, efforts to incorporate fish oils containing omega-3 fatty acids into general food products have occurred. The food products consist of beverages, salad dressings, mayonnaise, yogurt, ice cream, cookies, cakes, and processed meats.

Each of the aforementioned processes, while having some valuable effect, do not always provide for producing a palatable fish oil suitable for combining with general food products that are capable of long term storage.

It is therefore desired to develop an improved product and process for producing a food product containing fish oil with omega-3 fatty acids. The improved product must be suitable for long term storage such that the unsavory nature of the produced fish oil is reduced and the fish oil is palatable even after the food product has been stored for some time.

### BRIEF SUMMARY OF THE INVENTION

The present invention solves a number of the problems inherent in the prior art by providing a food composition comprising a food product combined with fish oil and a flavor stabilizing agent. The fish oil stabilizing agent provides protection of the fish oil against flavor and odor degradation and allows long term storage of the food composition containing the fish oil. The stabilizing agent comprises of between about 0.003 weight percent of the food composition to about 0.02 weight percent of the food composition. The stabilizing agent consists of the citrus flavonoid naringin that is extracted from grapefruit pulp and peel. The food product may be any suitable food composition or preparation, but is preferably a pourable salad dressing.

The fish oil is typically a non-hydrogenated refined menhaden oil containing long chain omega-3 fatty acids.

Other and further features and advantages will be apparent from the following description of presently preferred embodiments of the invention given for the purpose of disclosure.

### BRIEF DESCRIPTION OF THE SEVERAL VIEWS OF THE DRAWING

Not applicable.

### DETAILED DESCRIPTION OF THE INVENTION

In accordance with the present invention, a food composition has been developed by mixing into a food product a fish oil and a stabilizing agent, wherein the stabilizing agent is useful for stabilizing the fish oil against flavor and odor degradation. More specifically, the fish oil stabilizing agent disclosed is naringin which is a bitter citrus flavenoid derived from grapefruit peel and pulp and is the main bioflavonoid in grapefruit. Naringin itself, is a light yellow colored powder composed of small needle like crystals. Naringin imparts a majority of the bitter flavor associated with grapefruit and is slightly soluble in water (1 gram in 1000 ml of water at 20° C.). The bitter taste of naringin makes it suitable for use in a wide variety of food products; such as grapefruit and other citrus soft drinks, in tonic beverages, in orange marmalade, and in confectioneries such as chocolate and the like. The bitter taste of naringin is still detectable after being diluted to one part in 50,000 parts of water. Naringin can have a shelf life of more than two years if stored properly, such as in a full tightly closed containers at 25° C. and protected from heat, light, and moisture.

It was found that including naringin in a food composition containing fish oil, improved the storage stability of the resulting food composition. Storage stability of the food composition pertains to suppressing or eliminating any fish type flavor or odor that may be imparted to the food composition by the fish oil.

The fish oil of the present invention may include any suitable oil having as a constituent long chain omega-3 fatty acids. For example, oils prepared from fish containing long chain omega-3 fatty acids, either alone or in combination with other oils or any other suitable components. Blended oils, i.e., those oils containing oils prepared from fish in combination with oils prepared from other sources, such as vegetables, animals or the like, are suitable for use in the present invention.

In one method of preparation the food product is a pourable Italian salad dressing which is prepared to produce the final food composition. However, the food product component of the present invention disclosed herein is not limited to salad dressings but can include any food product to which fish oil is added. The food product disclosed herein is first produced by pre-blending all ingredients listed in Table 1. The food product ingredients, including each ingredient's respective weight percent, is shown in Table 1. First, the sugar, mustard flour, egg yolks, salt, sodium benzoate, and potassium sorbate components of the food product are dry blended. Using a high shear mixer the cellulose gel and xanthan is hydrated in water and then mixed for ten minutes. After ten minutes of mixing the oil is slowly added to the hydrated cellulose gel and xanthan mix. After adding the oil to the hydrated cellulose gel and xanthan, the vinegar and the dry blended ingredients are added as well. Finally, the dehydrated red pepper pieces, the dehydrated minced garlic, dehydrated oregano, and onion powder are mixed into the other ingredients. The final food composition is then mixed well until fully blended.

TABLE 1

| Ingredient | Percent (by weight) |
|---|---|
| Water | 56.80 |
| Vinegar, 50 grain | 20.00 |
| Vegetable oil/Fish oil | 10.00 |
| Granulated sugar | 8.00 |
| Salt | 2.00 |
| Cellulose gel (Avicel CL61 1, FMC) | 1.00 |
| Powdered egg yolks | 1.00 |
| Dehydrated red pepper pieces, −8 + 40 | 0.30 |
| Xanthan gum | 0.20 |
| Mustard flour | 0.20 |
| Dehydrated minced garlic | 0.20 |
| Dehydrated oregano | 0.10 |
| Onion powder | 0.10 |
| Sodium benzoate | 0.05 |
| Potassium sorbate | 0.05 |

Four different formulations were prepared of the above described food composition. The four formulations varied based on the type of oil added to the food composition and the amount of fish oil stabilizing agent. In the first formulation the oil component added to the food composition was a vegetable oil (soybean)—in each of the four different formulations the amount of oil added to the food composition was equal to about 10 weight percent of the food composition. The oil component of the second, third, and fourth formulation was a combination of fish oil and soybean oil. The soybean oil comprised about 8 weight percent of the food combination, and the fish oil comprised about 2 weight percent of the food combination. The fish oil was refined deodorized nonhydrofentated fish oil; each fish oil component contained 200 parts per million of tertiary butylhydroquinone (TBHQ) and 1,000 parts per million of mixed tocopherols. The preferred fish oil should be refined and deodorized and contain omega-3 fatty acids, and may be extracted from menhaden. However, the fish oil of the present invention may be produced from any suitable source, including sardines, herring, capelin, anchovy, cod liver, salmon, and mixtures thereof. The preferred mix of tocopherols is 50%. The third and fourth formulations each contained naringin at 0.005 per weight percent of the food composition and 0.01 per weight percent of the food composition respectively. The preferred amount of naringin added to the food composition therefore is from about 0.003 per weight percent of the total food composition to about 0.02 per weight percent of the total food composition.

One set of samples of the above mentioned four different formulations was stored at room temperature and another set of samples of each of the four different formulations was stored at 100° F. (to represent long term storage conditions). Each set of samples was sampled by an expert panel to evaluate various food attributes, such as color, off aroma, sweet, sour, salty, bitter, acidic, overall spice, off flavor-rancid, off flavor-fish, and mouthfeel-texture. Each food attribute was measured on a scale of 0 to 8, 0 being none, and 8 being extensive. The samples were tested immediately after being produced, and again at two weeks, at four weeks, and at eight weeks. The test results are compiled in Tables 2 through 8.

The results indicate that after eight weeks of storage at room temperature the samples containing naringin exhibited no fish flavor and were similar in taste profile to the control dressing that contained no fish oil. Conversely, the sample that contained fish oil without naringin exhibited detectable fish flavor.

TABLE 2
Pourable Italian Salad Dressing - 0 Time Storage

| | 10% | 8% Soybean | 0.005% | 0.01% |
|---|---|---|---|---|
| Attribute | Soybean | 2% Fish Oil | Naringen | Naringen |
| Color | 4.0 | 4.0 | 4.0 | 4.0 |
| (0 = very light, | | | | |
| 4 = typical, | | | | |
| 8 = very dark) | | | | |
| Off aroma | 0.0 | 0.0 | 0.0 | 0.0 |
| Description | | | | |
| Sweet | 3.6 | 3.6 | 3.6 | 3.6 |
| Sour | 1.1 | 1.1 | 1.1 | 1.1 |
| Salty | 4.2 | 4.2 | 4.2 | 4.2 |
| Bitter | 0.0 | 0.0 | 0.0 | 0.7 |
| Acidic | 4.1 | 4.1 | 4.1 | 4.1 |
| Overall spice | 4.4 | 4.4 | 4.4 | 4.4 |
| Overall flavor-rancid | 0.0 | 0.0 | 0.0 | 0.0 |
| Off flavor-rancid | 0.0 | 0.0 | 0.0 | 0.0 |
| Other | 0.0 | 0.0 | 0.0 | 0.0 |
| Describe | | | | |
| Mouthfeel-texture | 4.0 | 4.0 | 4.0 | 4.0 |
| (0 = very light, | | | | |
| 4 = typical, | | | | |
| 8 = too thick) | | | | |

TABLE 3
Pourable Italian Salad Dressing - 2 Weeks Storage at Room Temperature

| | 10% | 8% Soy bean | 0.005% | 0.01% |
|---|---|---|---|---|
| Attribute | Soybean | 2% Fish Oil | Naringen | Naringen |
| Color | 4.0 | 4.0 | 4.0 | 4.0 |
| (0 = very light, | | | | |
| 4 = typical, | | | | |
| 8 = very dark) | | | | |
| Off aroma | 0.0 | 0.5 | 0.0 | 0.0 |
| Description | | fish | | |
| Sweet | 3.6 | 3.6 | 3.6 | 3.6 |
| Sour | 1.1 | 1.1 | 1.1 | 1.1 |
| Salty | 4.2 | 4.2 | 4.2 | 4.2 |
| Bitter | 0.0 | 0.0 | 0.0 | 0.7 |
| Acidic | 4.1 | 4.1 | 4.1 | 4.1 |
| Overall spice | 4.4 | 4.4 | 4.4 | 4.4 |
| Off flavor-rancid | 0.0 | 0.0 | 0.0 | 0.0 |
| Off flavor-fish | 0.0 | 0.5 | 0.0 | 0.0 |
| Other | 0.0 | 0.0 | 0.0 | 0.0 |
| Describe | | | | |
| Mouthfeel-texture | 4.0 | 4.0 | 4.0 | 4.0 |
| (0 = very light, | | | | |
| 4 = typical, | | | | |
| 8 = too thick) | | | | |

TABLE 4
Pourable Italian Salad Dressing - 4 Weeks Storage at Room Temperature

| | 10% | 8% Soybean | 0.005% | 0.01% |
|---|---|---|---|---|
| Attribute | Soybean | 2% Fish Oil | Naringen | Naringen |
| Color | 4.0 | 4.0 | 4.2 | 4.2 |
| (0 = very light, | | | | |
| 4 = typical, | | | | |
| 8 = very dark) | | | | |
| Off aroma | 0.0 | 0.8 | 0.0 | 0.0 |
| Description | | fish | | |
| Sweet | 3.6 | 3.6 | 3.6 | 3.6 |
| Sour | 1.1 | 1.1 | 1.1 | 1.1 |
| Salty | 4.2 | 4.2 | 4.2 | 4.2 |
| Bitter | 0.0 | 0.0 | 0.0 | 0.5 |
| Acidic | 4.1 | 4.1 | 4.1 | 4.1 |
| Overall spice | 4.4 | 4.4 | 4.4 | 4.4 |
| Off flavor-rancid | 0.0 | 0.0 | 0.0 | 0.0 |
| Off flavor-fish | 0.0 | 0.5 | 0.0 | 0.0 |
| Other | 0.0 | 0.0 | 0.0 | 0.0 |
| Describe | | | | |
| Mouthfeel-texture | 4.0 | 4.0 | 4.0 | 4.0 |
| (0 = very light, | | | | |
| 4 = typical, | | | | |
| 8 = too thick) | | | | |

TABLE 5
Pourable Italian Salad Dressing - 8 Weeks Storage at Room Temperature

| | 10% | 8% Soybean | 0.005% | 0.01% |
|---|---|---|---|---|
| Attribute | Soybean | 2% Fish Oil | Naringen | Naringen |
| Color | 4.4 | 4.4 | 4.2 | 4.2 |
| (0 = very light, | | | | |
| 4 = typical, | | | | |
| 8 = very dark) | | | | |
| Off aroma | 0.0 | 1.8 | 0.0 | 0.0 |
| Description | | fish | | |
| Sweet | 3.6 | 3.6 | 3.6 | 3.6 |
| Sour | 1.1 | 1.1 | 1.1 | 1.1 |
| Salty | 4.2 | 4.2 | 4.2 | 4.2 |
| Bitter | 0.0 | 0.0 | 0.0 | 0.7 |
| Acidic | 4.1 | 4.1 | 4.1 | 4.1 |
| Overall spice | 4.4 | 4.4 | 4.4 | 4.4 |
| Off flavor-rancid | 0.0 | 0.0 | 0.0 | 0.0 |
| Off flavor-fish | 0.0 | 3.5 | 0.0 | 0.0 |
| Other | 0.0 | 0.0 | 0.0 | 0.0 |
| Describe | | | | |
| Mouthfeel-texture | 4.0 | 4.0 | 4.0 | 4.0 |
| (0 = very light, | | | | |
| 4 = typical, | | | | |
| 8 = too thick) | | | | |

TABLE 6
Pourable Italian Salad Dressing - 2 Weeks Storage at 100° F.

| | 10% | 8% Soybean | 0.005% | 0.01% |
|---|---|---|---|---|
| Attribute | Soybean | 2% Fish Oil | Naringen | Naringen |
| Color | 4.0 | 4.0 | 4.2 | 4.2 |
| (0 = very light, | | | | |
| 4 = typical, | | | | |
| 8 = very dark) | | | | |
| Off aroma | 0.0 | 1.8 | 0.0 | 0.0 |
| Description | | fish | | |
| Sweet | 3.6 | 3.4 | 3.6 | 3.6 |
| Sour | 1.1 | 1.1 | 1.5 | 1.8 |
| Salty | 4.2 | 4.2 | 4.2 | 4.2 |
| Bitter | 0.0 | 0.0 | 0.0 | 0.0 |
| Acidic | 4.1 | 3.5 | 4.1 | 4.1 |
| Overall spice | 4.4 | 3.5 | 4.5 | 4.5 |
| Off flavor-rancid | 0.0 | 0.0 | 0.0 | 0.0 |
| Off flavor-fish | 0.0 | 3.0 | 0.0 | 0.0 |
| Other | 0.0 | 0.0 | 0.0 | 0.0 |
| Describe | | | | |
| Mouthfeel-texture | 4.0 | 4.0 | 4.0 | 4.0 |
| (0 = very light, | | | | |
| 4 = typical, | | | | |
| 8 = too thick) | | | | |

TABLE 7
Pourable Italian Salad Dressing - 4 Weeks Storage at 100° F.

| | 10% | 8% Soy bean | 0.005% | 0.01% |
|---|---|---|---|---|
| Attribute | Soybean | 2% Fish Oil | Naringen | Naringen |
| Color | 4.0 | 4.0 | 4.5 | 4.5 |
| (0 = very light, | | | tan | tan |
| 4 = typical, | | | | |
| 8 = very dark) | | | | |
| Off aroma | 0.0 | 3.4 | 0.5 | 0.5 |
| Description | | fish | | |
| Sweet | 3.5 | 3.2 | 3.5 | 3.5 |
| Sour | 1.0 | 1.0 | 1.0 | 1.5 |
| Salty | 4.2 | 4.0 | 4.2 | 4.2 |
| Bitter | 0.0 | 0.0 | 0.0 | 0.0 |
| Acidic | 4.0 | 4.0 | 4.0 | 4.0 |
| Overall spice | 4.0 | 3.5 | 4.0 | 4.0 |
| Off flavor-rancid | 0.0 | 0.0 | 0.0 | 0.0 |
| Off flavor-fish | 0.0 | 5.5 | 0.0 | 0.0 |
| Other | 0.0 | 0.0 | 0.0 | 0.0 |
| Describe | | | | |
| Mouthfeel-texture | 3.5 | 3.5 | 3.5 | 3.5 |
| (0 = very light, | | | | |
| 4 = typical, | | | | |
| 8 = too thick) | | | | |

TABLE 8
Pourable Italian Salad Dressing - 8 Weeks Storage at 100° F.

| | 10% | 8% Soy bean | 0.005% | 0.01% |
|---|---|---|---|---|
| Attribute | Soybean | 2% Fish Oil | Naringen | Naringen |
| Color | 4.5 | 5.0 | 4.5 | 4.5 |
| (0 = very light, | sl. tan | brown/tan | | |
| 4 = typical, | | | | |
| 8 = very dark) | | | | |
| Off aroma | 1.0 | 5.2 | 0.5 | 0.0 |
| Description | rancid | fish | fish | |
| Sweet | 3.5 | 3.2 | 3.5 | 3.5 |
| Sour | 1.0 | 1.0 | 1.0 | 1.3 |
| Salty | 4.2 | 4.0 | 4.2 | 4.2 |
| Bitter | 0.0 | 0.0 | 0.0 | 0.0 |
| Acidic | 4.7 | 4.0 | 4.0 | 4.0 |
| Overall spice | 3.0 | 3.5 | 3.5 | 3.5 |
| Off flavor-rancid | 0.0 | 0.0 | 0.0 | 0.0 |
| Off flavor-fish | 0.0 | 6.5 | 1.0 | 0.5 |
| Other | 0.0 | 0.0 | 0.0 | 0.0 |
| Describe | | | | |
| Mouthfeel-texture | 3.5 | 3.5 | 3.5 | 3.5 |
| (0 = very light, | | | | |
| 4 = typical, | | | | |
| 8 = too thick) | | | | |

The present invention described herein, therefore, is well adapted to carry out the objects and attain the ends and advantages mentioned, as well as others inherent therein. While a presently preferred embodiment of the invention has been given for purposes of disclosure, numerous changes in the details of procedures for accomplishing the desired results will readily suggest themselves to those skilled in the art, and which are encompassed within the spirit of the present invention disclosed herein and the scope of the appended claims.

We claim:

1. A food composition comprising:
a food product;
fish oil;
a fish oil stabilizing agent for stabilizing said fish oil against flavor and odor degradation,
wherein said stabilizing agent comprises from between about 0.003 weight percent of said food composition to about 0.02 weight percent of said food composition.

2. The food composition of claim 1, wherein the fish oil stabilizing agent is naringin.

3. The food composition of claim 1, wherein the stabilizing agent comprises from between about 0.005 weight percent of the composition to about 0.01 weight percent of said food composition.

4. The food composition of claim 1, wherein said fish oil is a blended oil.

5. The food composition of claim 4, wherein said blended oil is comprised of a vegetable based oil.

6. The food composition of claim 4, wherein said blended oil is comprised of an animal based oil.

7. A food composition comprising a food product, fish oil, and a stabilizing agent:
wherein said food product is a pourable salad dressing;
Wherein said fish oil is a nonhydrogenated fish oil containing omega-3 fatty acids;
Wherein said stabilizing agent consists of naringin and stabilizes said fish oil against flavor and odor degradation;
Wherein said naringin comprises between about 0.003 weight percent of said food composition to about 0.02 weight percent of said food composition.
